(19) United States
(12) Patent Application Publication
(10) Pub. No.: US 2022/0116283 A1
(43) Pub. Date: Apr. 14, 2022

(54) RESTORING FUNCTIONALITY OF A WIRELESS DEVICE

(71) Applicant: ARRIS Enterprises LLC, Suwanee, GA (US)

(72) Inventor: Ju Li, Shenzhen, Guangdong (CN)

(21) Appl. No.: 17/279,776

(22) PCT Filed: Mar. 26, 2020
(86) PCT No.: PCT/CN2020/081404

§ 371 Date: Mar. 25, 2021

(51) Int. Cl. H04L 41/22; G06F 3/04842; H04L 41/0816

(52) U.S. Cl. CPC H04L 41/22; H04L 41/0816; G06F 3/04842

(57) ABSTRACT

An apparatus, method, and computer-readable recording medium restore functionality of a wireless device. Device settings are continuously stored as a plurality of data sets for the wireless device in a memory of the wireless device. A backup storing operation of the device settings is automatically performed at a predetermined time and on a periodic basis in the memory of the wireless device. When a failure of at least some function of the wireless device is detected, a restore mode is invoked from a user interface of the wireless device. The restore mode is implemented for restoring functionality of the at least some function of the wireless device by replacing device settings of the wireless device at the time of the detected failure with a data set of device settings in the memory stored during the backup storing operation during a previous time period when there was no failure detected.

### TECHNICAL FIELD

The subject matter of the present disclosure relates generally to restoring functionality of a wireless device.

### BACKGROUND

Wireless networks for providing services to client devices or end devices via a wireless modem/gateway device are prevalent in many homes and businesses. However, sometimes there can be problems with the operation of the modem/gateway device that interrupt services. For example, the modem/gateway device can stop working entirely, one or more of its functionalities can fail, or the modem/gateway device can exhibit glitches that cause the interruptions in services. Under these conditions, the user may be required to perform a reset of the modem/gateway device to the original factory default settings (e.g., hard reset) to correct the problem and restore the proper operation of the modem/gateway device.

However, a reset of the factory default settings of the modem/gateway device can cause the loss of previously set device settings, including clearing of all personal device settings (e.g., a wireless service set identifier (SSID), password, parental control, firewall level, blocking certain devices from accessing the internet, setup of special message channels for special software, MAC bridging, etc.) that a user has saved into the device settings for the modem/gateway device. Thus, after the reset of factory default settings of the modem/gateway device, the user is required to create new personal device settings or remember their previously-set personal device settings (e.g., SSID, password, parental control, firewall level, blocking certain devices from accessing the internet, setup of special message channels for special software, MAC bridging, etc.) and save them into the device settings, which is time consuming and thus takes away from the user's overall positive experience with the modem/gateway device.

To address this issue, some users save their personal device settings manually. For example, a backup file of the device settings including their personal device settings may be saved locally on the user's personal computer (PC). Similarly, a graphical user interface (GUI) of a wireless device may include a selection for a data backup function. However, in any of these conventional arrangements, it is cumbersome, time consuming, requires user effort, and thus generally unreliable, to continually save such settings manually. In addition, these conventional arrangements require a user to take the initiative to manually save their settings, either in a backup file on their PC or by using a data backup function of a wireless device. Generally, many users either do not remember to take such precautions, or they choose not to take such precautions, for the foregoing reasons. Even if a user does take the preemptive steps to save their personal device settings manually in this way, they may forget where these settings were stored at the time of a failure of at least some function of the wireless modem/gateway device.

Thus, it would be advantageous and an improvement over the relevant technology to provide an apparatus, system, method, and computer-readable recording medium capable of restoring functionality of the modem/gateway device after a failure of at least some function of the modem/gateway device has been detected without requiring a user to take the initiative and remember to manually save their personal device settings. It would also be advantageous and an improvement over the relevant technology to provide these features without requiring a user to invoke a reset or factory default restore operation on the modem/gateway device which would result in all of their personal user device settings being cleared as previously discussed.

### SUMMARY

An embodiment of the present disclosure provides a method for restoring functionality of a wireless device. The method includes continuously storing device settings as a plurality of data sets for the wireless device stored in a memory of the wireless device. The method further includes automatically performing a backup storing operation of the device settings at a predetermined time and on a period basis in the memory of the wireless device. In an embodiment of the present disclosure, the automatic backup storing operation is performed on a daily basis.

The method also includes detecting a failure of at least some function of the wireless device and invoking, from a user interface of the wireless device, a restore mode, the restore mode being implemented for restoring functionality of the at least some function of the wireless device. This is accomplished by replacing device settings of the wireless device at the time of the detected failure with a data set of device settings in the memory stored during the backup storing operation during a previous time period when there was no failure detected. In an embodiment of the present disclosure, the previous time period is twenty-four hours prior to a current time.

In an embodiment of the present disclosure, the device settings include one or more user settings that are input from a GUI of the user interface of the wireless device. The GUI is accessed using a mobile device connected to the wireless device. In an embodiment of the present disclosure, the one or more user settings have caused the at least some function of the wireless device to fail. The invoking of the restore mode includes pressing a physical button on the wireless device or making a selection using the mobile device connected to the wireless device.

An embodiment described in present disclosure provides a modem/gateway wireless device capable of restoring functionality. The modem/gateway wireless device includes a user interface; a GUI, a hardware processor; and a non-transitory memory configured to store one or more programs. The hardware processor executes the one or more programs to: continuously store device settings as a plurality of data sets for the modem/gateway wireless device stored in the non-transitory memory; automatically perform a backup storing operation of the device settings at a predetermined time and on a periodic basis in the non-transitory memory; and invoke a restore mode using the user interface or the GUI when a failure of at least some function of the modem/gateway wireless device is detected. The restore mode is implemented for restoring functionality of the at least some function of the modem/gateway wireless device by replacing device settings of the modem/gateway wireless device at the time of the detected failure with a data set of device settings in the non-transitory memory stored during the backup storing operation during a previous time period when there was no failure detected.

The user interface includes one or more physical buttons, and the restore mode is invoked after pressing the one or more physical buttons using a predetermined pressing sequence. The GUI includes a selection for the restore mode, and the restore mode is invoked by selecting the restore mode from the GUI using a mobile device connected to the modem/gateway wireless device.

An embodiment described in the present disclosure provides a system capable of restoring functionality to a modem/gateway device. The system includes a modem/gateway device with a user interface, a GUI, a hardware processor, a non-transitory memory storing one or more programs, and a network interface. The system also includes a mobile device including a user interface, a hardware processor, a non-transitory memory storing one or more programs, and a network interface; and a network connection configured to establish a wireless network connection with the network interface of mobile device and the network interface of the modem/gateway device.

The respective hardware processors of the modem/gateway device and the mobile device execute their respective one or more programs to cause the system to: continuously store device settings as a plurality of data sets for the modem/gateway device stored in memory of the modem/gateway device; automatically perform a backup storing operation of the device settings at a predetermined time and on a periodic basis in the memory of the modem/gateway device; detect a failure of at least some function of the modem/gateway device; and invoke, from the user interface or the GUI of the modem/gateway device, a restore mode, the restore mode being implemented for restoring functionality of the at least some function of the modem/gateway device by replacing device settings of the modem/gateway device at the time of the detected failure with a data set of device settings in the memory stored during the backup storing operation during a previous time period when there was no failure detected.

An embodiment described in the present disclosure provides a non-transitory computer-readable recording medium for restoring functionality of a wireless device. The non-transitory computer-readable recording medium storing one or more programs which when executed by a hardware processor performs steps of the methods described above.

### BRIEF DESCRIPTION OF THE DRAWINGS

In the drawings, like reference numbers generally indicate identical, functionally similar, and/or structurally similar elements.

FIG. 1 is a schematic diagram of a system according to an embodiment of the present disclosure;

FIG. 2 is a more detailed schematic diagram of a modem/gateway device and mobile device according to an embodiment of the present disclosure;

FIGS. 3A and 3B are exemplary user interfaces according to embodiments of the present disclosure; and

FIG. 4 is method and algorithm for restoring functionality of a wireless device according to an embodiment of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded as merely examples. Accordingly, those of ordinary skill in the art will recognize that various changes and modifications of the examples described herein can be made without departing from the spirit and scope of the present disclosure. In addition, descriptions of well-known functions and constructions may be omitted for clarity and conciseness.

The terms and words used in the following description and claims are merely used to enable a clear and consistent understanding of the present disclosure. Accordingly, it should be apparent to those skilled in the art that the following description of the present disclosure is provided for illustration purposes only, and not for the purpose of limiting the present disclosure as defined by the appended claims and their equivalents.

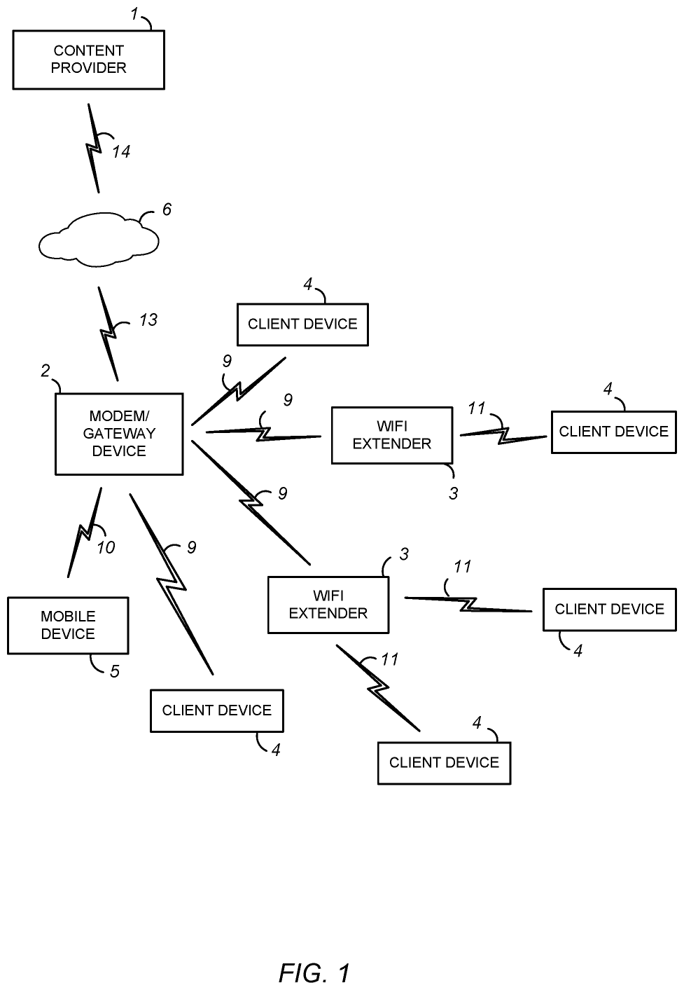

FIG. 1 is a schematic diagram of a system according to an embodiment of the present disclosure. As shown in FIG. 1, the main elements of the system includes a modem/gateway device 2 connected to a content provider 1 via the Internet 6 and also connected to different wireless devices such as client devices 4 and wireless extenders 3. Additionally, the modem/gateway device 2 is connected, for example, wirelessly to a mobile device 5.

The system shown in FIG. 1 includes wireless devices (e.g., extenders 3, client devices 4, and mobile device 5) that may be connected in one or more wireless networks (e.g., private, guest, iControl, backhaul network, or Internet of things (IoT) networks) within the system. Additionally, there could be some overlap between devices in the different networks. That is, one or more network devices could be located in more than one network. For example, wireless extenders 3 could be located both in a private network for providing content and information to a client device and also included in a backhaul network.

Starting from the top of FIG. 1, the content provider 1 may be a cable television provider, a satellite television provider, an internet service provider, or multiple system operators. The connection 14 between the Internet 6 and the content provider 1 can be implemented using a wide area network (WAN), a virtual private network (VPN), metropolitan area networks (MANs), system area networks (SANs), a public switched telephone network (PTSA), a global Telex network, or a 2G, 3G, 4G or 5G network. The connection 13 between the modem/gateway device 2 and the Internet 6 can be implemented using a digital subscriber line (DSL), a coaxial cable connection, a broadband mobile phone network connection, an optical network connection, or other similar connections. The connection 13 can also be implemented using a wireless connection that operates in accordance with, but is not limited to, IEEE 802.11 protocol, a Radio Frequency For Consumer Electronics (RF4CE) protocol, ZigBee protocol, Z-Wave protocol, or IEEE 802.15.4 protocol. It is also contemplated by the present disclosure that connection 13 is capable of providing connections between the modem/gateway device 2 and a WAN, a LAN, a VPN, MANs, PANs, WLANs, SANs, a PTSA, a global Telex network, or a 2G, 3G, 4G or 5G network

The modem/gateway device 2 is a hardware electronic device that performs the function of a stand-alone cable modem or a combination modem and gateway device that combines the functions of a modem and a router for providing content received from the content provider 1 to network devices (e.g., client devices, wireless extenders, and mobile device) in the system. It is also contemplated by the present disclosure that the modem/gateway device 2 can include the function of, but is not limited to, an Internet Protocol/Quadrature Amplitude Modulator (IP/QAM) set-top box (STB) or smart media device (SMD) that is capable of decoding audio/video content, and playing over-the-top (OTT) or multiple system operator (MSO) provided content.

The connection 9 between the modem/gateway device 2 and the wireless extenders 3 and client devices 4 can be implemented using a wireless connection in accordance with Bluetooth protocols (e.g., Bluetooth versions 1.0-3.0 and Bluetooth Low Energy (BLE) versions 4.0-5.0) or other short range protocols that operate in accordance with a wireless technology standard for exchanging data over short distances using short-wavelength UHF radio waves from 2.4 to 2.485 GHz.

Additionally, the connection 9 can be implemented using a wireless connection that operates in accordance with, but is not limited to, IEEE 802.11 protocol, RF4CE protocol, ZigBee protocol, Z-Wave protocol, or IEEE 802.15.4 protocol. It is also contemplated by the present disclosure that the connections 9 can include connections to a media over coax (MoCA) network.

The client devices 4 can be, for example, a hand-held computing device, a personal computer, an electronic tablet, a smart phone, smart speakers, an IoT device, an iControl device, or other similar wireless hand-held consumer electronic device capable of executing and displaying the content received through, for example, the modem/gateway device 2.

The wireless extenders 3 are hardware electronic devices that are used to extend the wireless network by receiving the signals transmitted by the modem/gateway device 2 and rebroadcasting the signals to client devices 4, which may out of range of the modem/gateway device 2. The wireless extenders 3 can also receive signals from the client devices 4 and rebroadcast the signals to the modem/gateway device 2, mobile device 5, or other client devices 4.

The connection 11 between the wireless extenders 3 and the client devices 4 are implemented through a wireless connection that operates in accordance with Bluetooth protocols (e.g., Bluetooth versions 1.0-3.0 and Bluetooth Low Energy (BLE) versions 4.0-5.0) or other short range protocols that operate in accordance with a wireless technology standard for exchanging data over short distances using short-wavelength UHF radio waves from 2.4 to 2.485 GHz. Additionally, the connection 11 can be implemented using a wireless connection that operates in accordance with, but is not limited to, IEEE 802.11 protocol, RF4CE protocol, ZigBee protocol, Z-Wave protocol, or IEEE 802.15.4 protocol.

The mobile device 5 can be, for example, a hand-held computing device, a personal computer, a smartphone, an electronic tablet, an e-reader, a personal digital assistant (PDA), or a portable music player with smart capabilities that is capable of connecting to the Internet, cellular networks, and interconnect with other devices via Wi-Fi and Bluetooth protocols. The connection 10 between the modem/gateway device 2 and the mobile device 5 is implemented through a wireless connection that operates in accordance with, but is not limited to, IEEE 802.11 protocol. The connection 10 can also be implemented using a wireless connection in accordance with Bluetooth protocols (e.g., Bluetooth versions 1.0-3.0 and Bluetooth Low Energy (BLE) versions 4.0-5.0) or other short range protocols that operate in accordance with a wireless technology standard for exchanging data over short distances using short-wavelength UHF radio waves from 2.4 to 2.485 GHz. Additionally, the connection 10 between the modem/gateway device 2 and the mobile device 5 can also be implemented through a WAN, a LAN, a VPN, MANs, PANs, WLANs, SANs, a PTSA, a global Telex network, or a 2G, 3G, 4G or 5G network.

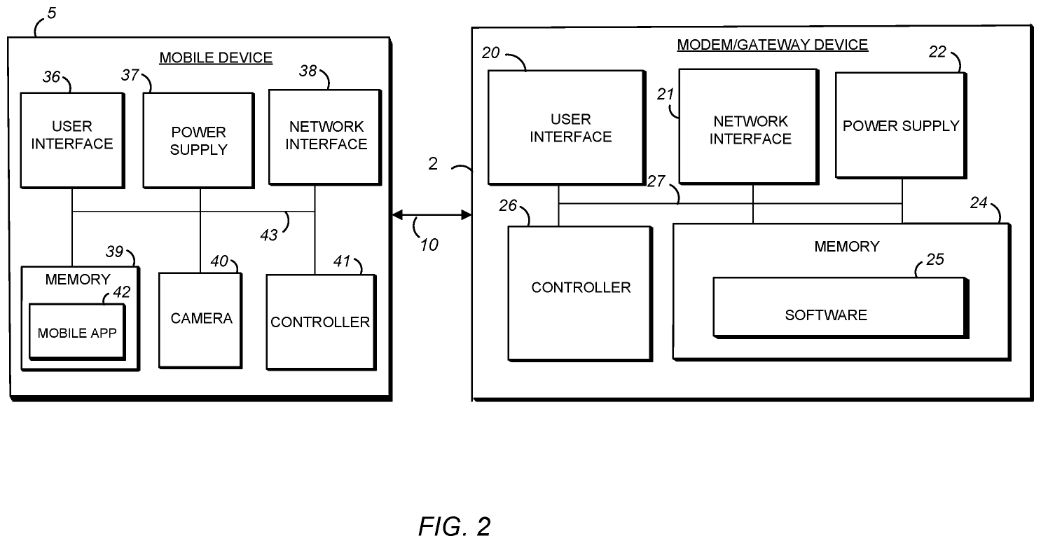

A detailed description of the exemplary internal components of the modem/gateway device 2 and mobile device 5 shown in FIG. 1 will be provided in the discussion of FIG. 2. However, in general, it is contemplated by the present disclosure that the modem/gateway device 2, the extenders 3, the client devices 4, and the mobile device 5 include electronic components or electronic computing devices operable to receive, transmit, process, store, and/or manage data and information associated with the system, which encompasses any suitable processing device adapted to perform computing tasks consistent with the execution of computer-readable instructions stored in a memory or a computer-readable recording medium.

Further, any, all, or some of the computing devices in the modem/gateway device 2, the extenders 3, the client devices 4, and the mobile device 5 may be adapted to execute any operating system, including Linux, UNIX, Windows, MacOS, DOS, and ChromOS as well as virtual machines adapted to virtualize execution of a particular operating system, including customized and proprietary operating systems. The modem/gateway device 2, the client device 4, the extenders 3, and mobile device 5 are further equipped with components to facilitate communication with other computing devices over the one or more network connections to local and wide area networks, wireless and wired networks, public and private networks, and any other communication network enabling communication in the system.

FIG. 2 illustrates a more detailed schematic diagram of an exemplary modem/gateway device 2 and the mobile device 5 in the system of FIG. 1 capable of restoring functionality of a wireless device according to an embodiment of the present disclosure. Although FIGS. 1 and 2 only show one mobile device 5, it is contemplated by the present disclosure that there could be more than one mobile device 5 and the mobile device 5 in FIGS. 1 and 2 is meant to be representative of the one or more mobile devices 5 that can be implemented in the system.

Now referring to FIG. 2 (e.g., from left to right), the mobile device 5 can be, for example, a hand-held computing device, a personal computer, a smartphone, an electronic tablet, an e-reader, a personal digital assistant (PDA), or a portable music player with smart capabilities that is capable of connecting to the Internet, cellular networks, and interconnect with other devices via Wi-Fi and Bluetooth. As shown in FIG. 2, the mobile device 5 includes a user interface 36, a power supply 37, a network interface 38, a memory 39, a camera 40, and a controller 41. The user interface 36 includes, but is not limited to, one or more physical buttons, one or more virtual buttons, a keyboard, a keypad, a liquid crystal display (LCD), cathode ray tube (CRT), thin film transistor (TFT), light-emitting diode (LED), high definition (HD) or other similar display device including a display device having touch screen capabilities so as to allow interaction between a user and the mobile device 5. The power supply 37 supplies power to the internal components of the mobile device 5 through the internal bus 43. The power supply 37 includes a self-contained power source such as a battery pack with an interface to be powered through an electrical charger connected to an outlet (e.g., either directly or by way of another device). The power supply 37 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The network interface 38 includes various network cards, interfaces, and circuitry implemented in software and/or hardware to enable communications with the modem/gateway device 2 using connection 10. The various network cards, interfaces, and circuitry enable communications via connection 10 using a wireless connection that operates in accordance with, but is not limited to, IEEE 802.11 protocol as well as a wireless connection that operates in accordance with Bluetooth protocols (e.g., Bluetooth versions 1.0-3.0 and Bluetooth Low Energy (BLE) versions 4.0-5.0) or other short range protocols that operate in accordance with a wireless technology standard for exchanging data over short distances using short-wavelength UHF radio waves from 2.4 to 2.485 GHz. The connection 10 between the modem/gateway device 2 and the mobile device 5 using the network interface 38 can also be implemented through the Internet, a computer network, a WAN, a LAN, a VPN, MANs, PANs, WLANs, SANs, a PTSA, a global Telex network, or a 2G, 3G, 4G or 5G network

The memory 39 includes a single memory or one or more memories or memory locations that include, but are not limited to, a random access memory (RAM), dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), hard disk or any other various layers of memory hierarchy.

The memory 39 can be used to store any type of instructions and software including software or mobile applications 42 associated with algorithms, processes, or operations for controlling the general functions and operations of the mobile device 5 for restoring functionality of a modem/gateway device 2 in accordance with the embodiments described in the present disclosure. The camera 40 is a standard camera of a camera phone that is able to capture photographs and record video.

The controller 41 controls the general operations of the mobile device 5 and includes, but is not limited to, a central processing unit (CPU), a hardware microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and performing the functions of the mobile device 5 in accordance with the embodiments described in the present disclosure. General communication between the components (e.g., 36-41) of the mobile device 5 is performed using the internal bus 43.

The modem/gateway device 2 is a hardware electronic device that performs the function of a stand-alone cable modem or a combination modem and gateway device that combines the functions of a modem and a router for providing content received from the content provider 1 to network devices (e.g., client devices, wireless extenders, and mobile device) in the system. It is also contemplated by the present disclosure that the modem/gateway device 2 can include the function of, but is not limited to, an Internet Protocol/Quadrature Amplitude Modulator (IP/QAM) set-top box (STB) or smart media device (SMD) that is capable of decoding audio/video content, and playing over-the-top (OTT) or multiple system operator (MSO) provided content.

As shown in FIG. 2, the modem/gateway device 2 includes a user interface 20, a network interface 21, a power supply 22, a memory 24, and a controller 26. The user interface 20 includes, but is not limited to, one or more physical buttons, one or more virtual buttons, a keyboard, a keypad, a graphical user interface (GUI) an LCD, a CRT, a TFT, an LED, an HD or other similar display device including a display device having touch screen capabilities so as to allow interaction between a user and the modem/gateway device 2. The network interface 21 includes various network cards, and circuitry implemented in software and/or hardware to enable communications with the client devices 4 and WiFi extenders 3 using connection 9 and with the mobile device 5 using connection 10.

The various network cards, interfaces, and circuitry of the network interface 21 enable communications via connection 9 using a wireless protocol in accordance with, but is not limited to, Bluetooth protocols (e.g., Bluetooth versions 1.0-3.0 and Bluetooth Low Energy (BLE) versions 4.0-5.0) or other short range protocols that operate in accordance with a wireless technology standard for exchanging data over short distances using short-wavelength UHF radio waves from 2.4 to 2.485 GHz. Additionally, the various network cards, interfaces, and circuitry of the network interface 21 enable communications via connection 9 using a wireless connection that operates in accordance with, but is not limited to, IEEE 802.11 protocol, RF4CE protocol, ZigBee protocol, Z-Wave protocol, or IEEE 802.15.4 protocol.

The various network cards, interfaces, and circuitry of the network interface 21 enable communications via connection 10 to the mobile device 5 using a wireless protocol that operates in accordance with, but is not limited to, IEEE 802.11 protocol as well as wireless protocol in accordance with, but is not limited to, Bluetooth protocols (e.g., Bluetooth versions 1.0-3.0 and Bluetooth Low Energy (BLE) versions 4.0-5.0) or other short range protocols that operate in accordance with a wireless technology standard for exchanging data over short distances using short-wavelength UHF radio waves from 2.4 to 2.485 GHz. The connection 10 between the modem/gateway device 2 and the mobile device 5 using the network interface 21 can also be through the Internet, a computer network, a WAN, a LAN, a VPN, MANs, PANs, WLANs, SANs, a PTSA, a global Telex network, or a 2G, 3G, 4G or 5G network.

The power supply 22 supplies power to the internal components of the modem/gateway device 2 through the internal bus 27. The power supply 22 can be a self-contained power source such as a battery pack with an interface to be powered through an electrical charger connected to an outlet (e.g., either directly or by way of another device). The power supply 22 can also include a rechargeable battery that can be detached allowing for replacement such as a NiCd, a NiMH, a Li-ion, or a Li-pol battery.

The memory 24 includes a single memory or one or more memories or memory locations that include, but are not limited to, a RAM, a DRAM, a memory buffer, a hard drive, a database, an EPROM, an EEPROM, a ROM, a flash memory, logic blocks of a FPGA, hard disk or any other various layers of memory hierarchy. The memory 24 can be used to store any type of instructions or software including software 25 associated with algorithms, processes, or operations for controlling the general functions and operations of the modem/gateway device 2 for restoring functionality of the modem/gateway device 2 in accordance with the embodiments described in the present disclosure.

The controller 26 controls the general operations of the modem/gateway device 2 and includes, but is not limited to, a CPU, a hardware microprocessor, a multi-core processor, a single core processor, a FPGA, a microcontroller, an ASIC, a DSP, or other similar processing device capable of executing any type of instructions, algorithms, or software for controlling the operation and performing the functions of the modem/gateway device 2 in accordance with the embodiments described in the present disclosure. Communication between the components (e.g., 20-22, 24, and 26) of the modem/gateway device 2 is established using the internal bus 27.

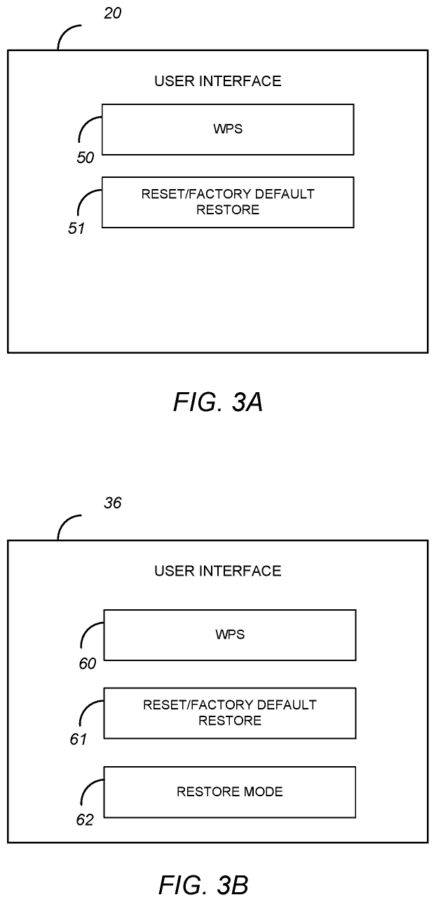

FIGS. 3A and 3B illustrate exemplary user interfaces according to embodiments of the present disclosure.

As shown in FIG. 3A, the user interface 20 of the modem/gateway device 2 may include physical buttons 50, 51. As shown in FIG. 3A, the buttons include a wireless protected setup (WPS) button 50, and a reset/factory default restore button 51. It is contemplated by the present disclosure that the WPS button 50 can be used to initiate a WPS process for connecting a WPS-enabled device (e.g., client device 4 or extender 3) to a wireless network (e.g., a private network) in the system. The wireless networks of the system are established, effected, or hosted by the modem/gateway device 2. Additionally, the reset/factory default restore button 51 can be used to perform a reset or factory default restore operation (i.e., hard reset) of the device settings for the modem/gateway device 2. There may be occasions when a user needs to reset the cable modem/gateway device 2 to the factory default settings, for example, if the user forgets or loses a username and password, or if modem/gateway device 2 stops working or is not working properly.

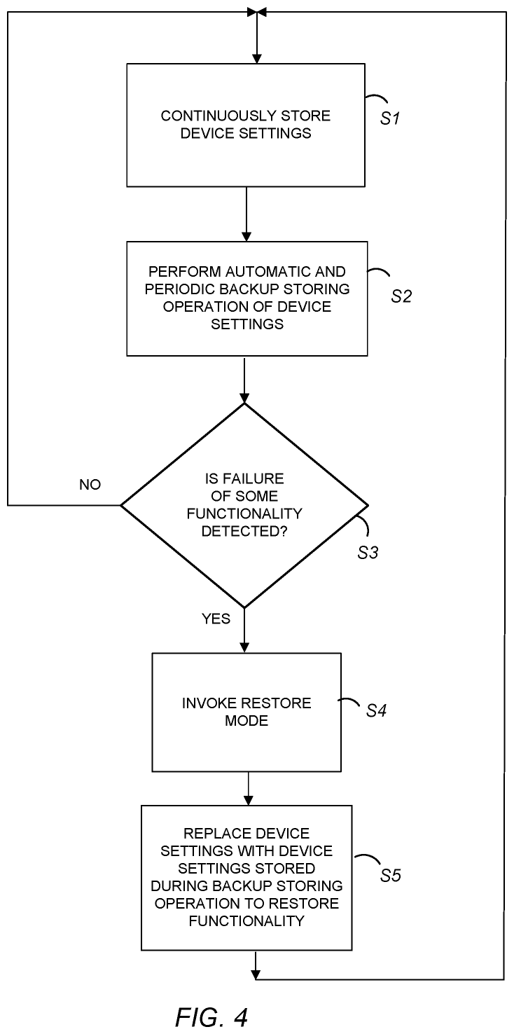

The reset or factory default will generally restore proper operation of the modem/gateway device 2, but will reset the previously set device settings to the factory default settings. By implementing the methods and algorithms of FIG. 4 and the user interface of FIG. 3A, the user is able to restore functionality of the modem/gateway device 2 without performing a reset or factory default restore operation. For example, by using a predetermined pressing sequence of the WPS button 50 and/or the reset or factory default restore button 51, the user can initiate or invoke a restore mode. For example, the user can press the WPS button 50 while pressing the reset or factory default restore button 51, or the user can press either the WPS button 50 or factory default restore button 51 for a predetermined amount of time (e.g., 30 seconds or longer).

Once the restore mode is invoked, functionality of the modem/gateway device 2 will be restored by replacing device settings of the modem/gateway device 2 at the time of the detected failure with a data set of device settings in the memory 24 stored during an automatic backup storing operation during a previous time period when there was no failure detected.

As shown in FIG. 3B, the user interface 36 of the mobile device 5 may include the use, for example, virtual buttons or selection options 60-62. As shown in FIG. 3B, the virtual buttons or selection options 60-62 include a WPS button or selection 60, a reset/factory default restore button or selection 61, and a restore mode button or selection 62. The buttons or selections 60-62 of the mobile device 5 can be implemented in combination with a graphical user interface (GUI) of the modem/gateway device 2. That is, the user can connect to the GUI of the modem/gateway device 2 using a browser of the mobile device 5 and the address of the modem/gateway device (e.g., http:192.168.0.1). In the alternative, the user can connect to the GUI of the modem/gateway device 2 using software or a mobile application 42 stored in the mobile device 5. Once connected to the modem/gateway device 2, the user of the mobile device 5 can be presented with the virtual buttons or selection options 60-62. The WPS button or selection 60 can be used to initiate a WPS process for connecting a WPS-enabled device (e.g., client device 4 or extender 3) to a wireless network (e.g., a private network). Additionally, the reset/factory default restore button or selection 61 can be implemented to perform a reset or factory default restore operation of all the device settings for the modem/gateway device 2. The restore mode button or selection 62 can be used to select and initiate or invoke the restore mode.

Once the restore mode is invoked, functionality of the modem/gateway device 2 is restored by replacing device settings of the modem/gateway device 2 at the time of the detected failure with a data set of device settings in the memory stored during a backup storing operation during a previous time period when there was no failure detected. The continuous storing of device settings and automatic performing of the backup storing operation of the device settings are described in detail with reference to FIG. 4.

FIG. 4 is method and algorithm for restoring functionality of a wireless device according to an embodiment of the present disclosure.

In FIG. 4, the method and algorithm illustrate exemplary operations performed by, the example, the software 25 executed by the controller 26 of the modem/gateway device 2 prior to, when, and after a user invokes the restore mode from the user interface 20 shown in FIG. 3A. The method and algorithm of FIG. 4 also illustrate exemplary operations performed by the software or mobile application 42 executed by the controller 41 of the mobile device 5 prior to, when, and after a user invokes the restore mode from the user interface 36 shown in FIG. 3B.

As noted previously, the user can connect to the GUI of the modem/gateway device 2 using a browser of the mobile device 5 and the address of the modem/gateway device (e.g., http:192.168.0.1). In the alterative, the user can connect to the GUI of the modem/gateway device 2 using software or a mobile application 42 stored in the mobile device 5. Once connected to the modem/gateway device 2, the user of the mobile device 5 can be presented with the GUI of the modem/gateway device 2 for changing settings of the modem/gateway device 2. The GUI may be, for example, 30-40 pages long which provides a user an opportunity to implement a wide variety of user-specific configurations via personalized user settings that are input by a user via the GUI of the user interface 20 of the modem/gateway device 2.

Using this GUI, a user is able to set numerous personalized user settings according to their own specific needs. For example, the user can select, among other personal device user settings, a current WiFi SSID and password. Other personal device user settings that can be set on the GUI include, but are not limited to, parental controls, accessible via a Parental Control tab in an example, firewall levels, accessible via a Firewall tab in an example, the ability to block certain devices from accessing the Internet, setup of special message channels for specific software, and other security and configuration settings for the modem/gateway device 2. An example of a firewall level settings page of a GUI includes a Firewall Security Level section that allows a user to set their desired firewall security level, namely Maximum Security (High), Typical Security (Medium), and Minimum Security (Low).

Thus, the device settings included in the GUI for the modem/gateway device 2 includes both manufacturer or default settings as well as one or more user settings that have been personalized by a user of the modem/gateway device 2 and have been input from the GUI of the user interface of the modem/gateway device 2 as per the foregoing discussion.

Another example of a user customizable setting in a GUI is the MAC Bridging feature. A MAC Bridging feature settings page is accessed under an Advanced tab in an example of a GUI.

The inventor of the present application has recognized that there are several scenarios that may arise which can cause at least some function of the modem/gateway device 2 to fail.

Some individual settings and certain combinations of settings of the modem/gateway device 2 often cause particular user-required or user-desired functionality of the modem/gateway device 2 to fail. One example of this situation is if the user sets the firewall level setting to “Disable entire firewall” in an embodiment this may result in the IPv4 (Internet Protocol version 4) of the Internet Control Message Protocol (ICMP) and associated browsing to stop working. As a result, the user can no longer navigate the Internet because the firewall level was set in this way. In some instances, a setting or combination of settings will result in all, or nearly all, of the modem/gateway device functionality to not work properly. The problem may result from a design flaw or a bug that was not detected during the research and development phase of manufacturing the modem/gateway device 2.

In many cases, the user may not know which setting or combination of settings has caused a failure in functionality, or at least some functionality, of the modem/gateway device. For example, a user may have made a number of different personal settings into the GUI of the modem/gateway device 2 resulting in the user not being able to simply implement a manual setting change back to a previous setting to restore functionality of the modem/gateway device 2. As a result, it would be advantageous to provide users with a way to restore settings of the modem/gateway device 2 to settings of a previous time period when there was no such failure detected. This would result in the gateway functionality being restored while also avoiding the need to perform a reset or factory default restore operation of all the device settings for the modem/gateway device 2. As previously discussed, a reset or factory default restore operation would result in all of the user's previously customized personal user settings being cleared from the GUI.

A user may not be aware of the interrelations between various device settings and functionalities. For example, changes to one function may cause other functions to fail. This may not be a bug, but may instead be a specific design intended for the modem/gateway device 2. Nevertheless, it may not be a result that the user expects. For example, a user may have set a port forwarding rule to allow for receipt of a particular incoming message. In an example of a GUI, the port forwarding rule can be set in a Port Forwarding tab under an Advanced tab of the GUI. The user may then modify the gateway's LAN IP address for some other need. This combination of activities or settings can result in the port forwarding rule that was set by the user being automatically deleted. As a result, it would be advantageous to provide the user with a quick and easy way to restore the settings of the modem/gateway device 2 to settings of a previous time period before the undesirable combination of activities or settings occurred. Such a feature could improve the user's overall experience with using the modem/gateway device.

As another example of a scenario which can cause at least some function of the modem/gateway device 2 to fail, the user may make a mistake when entering settings on the GUI of the modem/gateway device 2. For example, the user may make an unintended setting that is not needed or desired. However, the user may not remember what they changed on the GUI that caused the device functionality to fail, or the user may not know how to change the setting back to its original value. As a result, it would be advantageous to provide the user with a quick and easy way to restore the settings of the modem/gateway device 2 to settings of a previous time period before the undesirable combination of activities or settings occurred. Such a feature could improve the user's overall experience with using the modem/gateway device.

As another example of a scenario which can cause at least some function of the modem/gateway device 2 to fail, the user may make an intended setting or settings, but then is not satisfied with the result and would like a quick way to recover the previous setting or settings. For example, the user may set the Guest WiFi network on their gateway to share 45% of the airtime. The user may soon become aware that this setting results in the performance of their Home network being affected in an undesired manner. As a result, it would be advantageous to provide the user with a quick and easy way to restore the settings of the modem/gateway device 2 to settings of a previous time period before the undesired result occurred. Such a feature could improve the user's overall experience with using the modem/gateway device.

In each of the scenarios discussed above, the ability to replace device settings of the modem/gateway device 2 at the time of the detected failure or undesired results with a data set of device settings from a previous time period when there was no such detected failure or undesired results would be particularly advantageous and useful.

In step S1 of the method and algorithm for restoring functionality of a wireless device according to an embodiment of the present disclosure shown in FIG. 4, the device settings in the GUI of the modem/gateway device 2 are continuously stored in the memory 24 of the modem/gateway device 2. This continuous storing of device settings of step S1 occurs while a user may be making changes to certain device settings, as previously discussed, for example. The continuous storing of device settings occurs in the background while such changes are being made and/or while the modem/gateway device 2 is otherwise performing its usual functions.

In step S2, a backup storing operation of the device settings is automatically performed at a predetermined time and on a periodic basis in the memory 24 of the modem/gateway device 2. In an embodiment of the present disclosure, the automatic backup storing operation is performed on a daily basis at a predetermined time, such as at midnight. In an embodiment of the present disclosure, in order to save storage space, each automatically saved configuration file of the device settings that is stored in memory 24 in the backup storing operation of step S2 overwrites the previously-stored configuration file of the device settings from a previous iteration of the backup storing operation of step S2.

In step S3, a determination is made as to whether at least some function of the modem/gateway device 2 has failed. For example, this may be a failure of any user-required or user-desired functionality of the modem/gateway device 2 as discussed above, or more seriously, it may also be a failure of most or all functionality of the modem/gateway device 2. In an embodiment of the present disclosure, the failure is caused by one or more user settings that have been input by a user into the user interface 20, or GUI, of the modem/gateway device 2 in, for example, any of the specific scenarios described in the foregoing discussion.

If such a determination is made in step S3, the user invokes, in step S4, from the user interface 20 of the modem/gateway device 2, the restore mode on the modem/gateway device 2. Using the user interface 20 of FIG. 3A, the user can implement a predetermined pressing sequence of the physical WPS button 50 and/or the reset or factory default restore button 51 to initiate or invoke a restore mode. For example, the user can press the WPS button 50 while pressing the reset or factory default restore button 51, or the user can press either the WPS button 50 or factory default restore button 51 for a predetermined amount of time (e.g., 30 seconds or longer). Please note that the pressing sequence to initiate or invoke the restore mode can be modified and/or be varied by, for example, reprogramming the modem/gateway device 2. Additionally, the user can also select a restore mode button or selection 62 or other similar selection option presented from the GUI of the modem/gateway device 2. That is, the user can connect to the GUI of the modem/gateway device 2 using a browser of the mobile device 5 and the address of the modem/gateway device (e.g., http:192.168.0.1). In the alterative, the user can connect to the GUI of the modem/gateway device 2 using software or a mobile application 42 stored in the mobile device 5.

Once the restore mode is invoked in step S4, the functionality of the at least some function of the modem/gateway device 2 that has failed, as was detected in step S3, is restored in step S5. The restoration of the at least some functionality of the modem/gateway device 2 in step 5 is achieved by replacing device settings of the modem/gateway device 2 at the time of the detected failure with a data set of device settings in the memory 24 stored during the automatic and periodic backup storing operation of step S2 during a previous time period when there was no failure detected. In an embodiment of the present disclosure, the previous time period is twenty-four hours prior to a current time. However, this time period may be user-defined as a timer, for example, the timer may be set to daily, weekly, or monthly.

Using the methods and algorithms for implementing the restoring of functionality of a modem/gateway device 2, when a user makes a mistake in entering user settings, or when a user otherwise enters one or more user settings that results in a failure of at least some function of a wireless device, the user can quickly and easily restore functionality of the at least some function of the wireless device that has failed. This is achieved by the user invoking a restore mode that replaces device settings of the wireless device at the time of the detected failure with a data set of device settings in the memory stored during the automatic and periodic backup storing operation during a previous time period when failure of the at least some function of the wireless device was not detected. This advantageously results in the functionality of the wireless device being restored while also avoiding the need to perform a reset or factory default restore operation of all the device settings for the wireless device. As discussed previously, such a reset or factory default restore operation would result in all of the user's previously customized personal user settings being cleared from the GUI.

In addition, it is generally not common for users to take preemptive steps to consciously back up their personal data settings before modifying the settings in the GUI. By continuously storing device settings in the background and performing an automatic and periodic backup storing operation of the device settings, a user does not need to take the initiative, or need to remember, to back up the data as compared to an existing data backup functions such as a user manually backing up the data locally on their personal computer (PC) of by a manual data backup function provided on a GUI of a wireless device.

The present disclosure may be implemented as any combination of an apparatus, a system, an integrated circuit, and a computer program on a non-transitory computer readable recording medium. The one or more processors may be implemented as an integrated circuit (IC), an application specific integrated circuit (ASIC), or large scale integrated circuit (LSI), system LSI, super LSI, or ultra LSI components that perform a part or all of the features of the embodiments described in the present disclosure.

The present disclosure includes the use of software, applications, computer programs, or algorithms. The software, applications, computer programs, or algorithms can be stored on a non-transitory computer-readable medium for causing a computer, such as the one or more processors, to execute the steps described in FIG. 4. For example, the one or more memories stores software or algorithms with executable instructions and the one or more processors can execute a set of instructions of the software or algorithms in association the performing the features of the embodiments described in the present disclosure.

The software and computer programs, which can also be referred to as programs, software applications, applications, components, or code, include machine instructions for a programmable processor, and can be implemented in a high-level procedural language, an object-oriented programming language, a functional programming language, a logical programming language, or an assembly language or machine language. The term computer-readable recording medium refers to any computer program product, apparatus or device, such as a magnetic disk, optical disk, solid-state storage device, memory, and programmable logic devices (PLDs), used to provide machine instructions or data to a programmable data processor, including a computer-readable recording medium that receives machine instructions as a computer-readable signal.

By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Use of the phrases “capable of,” “capable to,” “operable to,” or “configured to” in one or more embodiments, refers to some apparatus, logic, hardware, and/or element designed in such a way to enable use of the apparatus, logic, hardware, and/or element in a specified manner. The subject matter of the present disclosure is provided as examples of apparatus, systems, methods, and programs for performing the features of the embodiments described in the present disclosure. However, further features or variations are contemplated in addition to the features described above. It is contemplated that the implementation of the components and functions of the present disclosure can be done with any newly arising technology that may replace any of the above implemented technologies.

Additionally, the above description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, features described with respect to certain embodiments may be combined in other embodiments.

We claim:

1. A method for restoring functionality of a wireless device, the method comprising:
continuously storing device settings as a plurality of data sets for the wireless device stored in a memory of the wireless device;
automatically performing a backup storing operation of the device settings at a predetermined time and on a periodic basis in the memory of the wireless device;
detecting a failure of at least some function of the wireless device; and
invoking, from a user interface of the wireless device, a restore mode, the restore mode being implemented for restoring functionality of the at least some function of the wireless device by replacing device settings of the wireless device at the time of the detected failure with a data set of device settings in the memory stored during the backup storing operation during a previous time period when there was no failure detected.

2. The method according to claim 1, wherein the device settings include one or more user settings that are input from a graphical user interface (GUI) of the user interface of the wireless device.

3. The method according to claim 2, wherein the GUI is accessed using a mobile device connected to the wireless device.

4. The method according to claim 1, wherein the automatic backup storing operation is performed on a daily basis.

5. The method according to claim 1, wherein the previous time period is twenty-four hours prior to a current time.

6. The method according to claim 1, wherein the invoking of the restore mode includes pressing a physical button on the wireless device or making a selection using a mobile device connected to the wireless device.

7. The method according to claim 2, wherein the one or more user settings have caused the at least some function of the wireless device to fail.

8. A non-transitory computer-readable recording medium for restoring functionality of a wireless device, the non-transitory computer-readable recording medium storing one or more programs which when executed by a hardware processor performs steps comprising:
continuously storing device settings as a plurality of data sets for the wireless device stored in memory of the wireless device;
automatically performing a backup storing operation of the device settings at a predetermined time and on a periodic basis in the memory of the wireless device;
detecting a failure of at least some function of the wireless device; and
invoking, from a user interface of the wireless device, a restore mode, the restore mode being implemented for restoring functionality of the at least some function of the wireless device by replacing device settings of the wireless device at the time of the detected failure with a data set of device settings in the memory stored during the backup storing operation during a previous time period when there was no failure detected.

9. The non-transitory computer-readable recording medium according to claim 8, wherein the device settings include one or more user settings that are received at the user interface of the wireless device.

10. The non-transitory computer-readable recording medium according to claim 9, wherein the user interface of the wireless device is a Graphical User Interface (GUI).

11. The non-transitory computer-readable recording medium according to claim 10, wherein the GUI is accessed using a mobile device connected to the wireless device.

12. The non-transitory computer-readable recording medium according to claim 9, wherein the one or more user settings have caused the at least some function of the wireless device to fail.

13. The non-transitory computer-readable recording medium according to claim 8, wherein the invoking of the restore mode includes pressing a physical button on the wireless device or making a selection using a mobile device connected to the wireless device.

14. The non-transitory computer-readable recording medium according to claim 8, wherein the automatic backup storing operation is performed on a daily basis.

15. A modem/gateway wireless device capable of restoring functionality comprising:
a user interface;
a graphical user interface (GUI);
a hardware processor; and
a non-transitory memory configured to store one or more programs,
wherein the hardware processor executes the one or more programs to:
continuously store device settings as a plurality of data sets for the modem/gateway wireless device stored in the non-transitory memory;
automatically perform a backup storing operation of the device settings at a predetermined time and on a periodic basis in the non-transitory memory; and
invoke a restore mode using the user interface or the GUI when a failure of at least some function of the modem/gateway wireless device is detected, the restore mode being implemented for restoring functionality of the at least some function of the modem/gateway wireless device by replacing device settings of the modem/gateway wireless device at the time of the detected failure with a data set of device settings in the non-transitory memory stored during the backup storing operation during a previous time period when there was no failure detected.

16. The modem/gateway wireless device according to claim 15, wherein the device settings include one or more user settings that are received at the GUI.

17. The modem/gateway wireless device according to claim 15, wherein the GUI is accessed using a mobile device connected to the modem/gateway wireless device.

18. The modem/gateway wireless device according to claim 15, wherein the user interface includes one or more physical buttons, and the restore mode is invoked after pressing the one or more physical buttons using a predetermined pressing sequence.

19. The modem/gateway wireless device according to claim 16, wherein the one or more user settings have caused the at least some function of the modem/gateway wireless device to fail.
